(19) United States
(12) Patent Application Publication
(10) Pub. No.: US 2017/0081961 A1
(43) Pub. Date: Mar. 23, 2017

(54) TURBOENGINE BLADING MEMBER

(71) Applicant: ANSALDO ENERGIA IP UK LIMITED, London (GB)

(72) Inventors: Herbert BRANDL, WALDSHUT-TIENGEN (DE); Joerg KRUECKELS, BIRMENSTORF (CH); Thomas ZIERER, ENNETBADEN (CH)

(73) Assignee: ANSALDO ENERGIA IP UK LIMITED, London (GB)

(21) Appl. No.: 15/271,806

(22) Filed: Sep. 21, 2016

(30) Foreign Application Priority Data
Sep. 22, 2015 (EP) 15186278.6

(51) Int. Cl. F01D 5/18; F01D 5/30

(52) U.S. Cl. CPC F01D 5/187; F01D 5/3015; F05D 2220/32; F05D 2240/24; F05D 2240/303; F05D 2240/304; F05D 2240/305; F05D 2240/306; F05D 2240/307; F05D 2240/80

(57) ABSTRACT

A turboengine blading member includes at least one airfoil and at least one platform provided at least one of a base and a tip of the airfoil. The airfoil has a profile body, a leading edge provided at a first side of the profile body, and a trailing edge section extending from a second side of the profile body and opposite the leading edge. The profile body is connected to the at least one platform. The trailing edge section cantilevers from the profile body and is provided without connection to the platform.

### TECHNICAL FIELD

The present disclosure relates to a turboengine blading member as set forth in claim 1, and further to an airfoil member for a turboengine blading member.

### BACKGROUND OF THE DISCLOSURE

Turboengine blading members comprise at least one airfoil and one platform. A platform may be provided only at one end, that is, either a base or a tip, of the airfoil, such that the airfoil extends along its spanwidth from the platform. In other embodiments, so-call shrouded blades, a platform is provided on both ends of the airfoil, such that the airfoil extends along its spanwidth between two platforms.

Moreover, a blading member may comprise a multitude of at least two airfoils, such that two or more airfoils extend from one platform, or between two platforms, respectively.

A blading member may be provided on a turboengine rotor as a rotating blading member, or as part of a turboengine stator as a stationary blade member which may also be referred to as a vane member.

The airfoil exhibits an aerodynamic profile with a leading edge and a trailing edge, a flow direction being defined from the leading edge towards the trailing edge, and a suction side and a pressure side extending therebetween. It will be appreciated that the leading edge and the trailing edge extend at least essentially along the spanwidth. The airfoil further comprises a profile body, which, at least for the case of blading members being intended for use in subsonic flows, is concavely curved along the flow direction at the pressure side of the airfoil and is convexly curved along the flow direction at the suction side. The airfoil profile may be differently contoured in the case of airfoils intended for use in transonic or supersonic flows. However, the skilled person will readily appreciate the presence of location the pressure side and the suction side, for instance by the orientation of the chord line, extending as a straight line between the leading and the trailing edge, on the platform. The airfoil body further exhibits a profile thickness. The leading edge is provided at a first, upstream side of the profile body, and may, in particular in the case of expansion turbine blade members, be generally rounded such that a maximum profile thickness of the profile body is achieved a fairly short distance downstream the leading edge. On a downstream side, the airfoil tapers in a trailing edge section from the profile body towards the trailing edge, which is provided as an essentially sharp edge, with an edge radius significantly smaller than the radius of the leading edge. The trailing edge provides for a flow separation, thus preventing pressure equalization between the pressure side and the suction side of the airfoil, and thus, on the one hand, causes, in case of a rotating blade, a driving force directed from the pressure side to the suction side, and moreover defining the downstream flow direction. The thinner the trailing edge section is, and the closer the trailing edge resembles actually sharp edge, the higher the aerodynamic efficiency of the blading member may be considered.

By virtue of these geometric and aerodynamic considerations it will be readily appreciated that the trailing edge section resembles a thin, yet tapered, sheet of material.

In the expansion turbine of state-of-the art turboengines the blading members are charged with extreme thermal loading, and, in the first stages of the expansion turbine of internal combustion turbines, require cooling. The airfoils are thus commonly equipped with internal coolant ducts. Coolant from the internal coolant ducts is commonly discharged at least partially at through trailing edge coolant discharge slots.

Mechanical stresses are particularly emphasized at a junction of the airfoil and the platform. On the one hand this is due to aerodynamic forces acting on the airfoil which need to be supported at the platform. Further, in running blading members, centrifugal forces act on the airfoil. At the junction of the airfoil and the platform, due to the limited transition radius, notch effects come into play. Moreover, due to different cooling and thermal loading of the platform and the airfoil, additional stresses may be induced due to a mismatch in thermal expansion. Due to the specific geometry, comprising low material thickness, the trailing edge section is particularly vulnerable to mechanical and thermal loading. In particular in a transition region between the airfoil trailing edge and the platform, a multitude of stress inducing and enhancing effects come into play which may compromise the fatigue strength and even induce cracks. The stresses get further pronounced if the airfoil and the platform are manufactured and assembled from different materials, or according to different processes, such that both components exhibit different thermal expansion coefficients. Similar conclusions mutadis mutandis apply in the case of built blading members, which comprise an airfoil member and a blading member, as for instance described in U.S. Pat. No. 5,797,725. A fixation post of the blading member is provided at at least one of an airfoil base and an airfoil tip. The fixation post is received in a receiver opening of the platform member, and is on a far end exposed to coolant, while the airfoil member is exposed to a hot working fluid flow. This may result in considerable temperature gradients, and again in significant stress concentrations in a transition area between the fixation post and the airfoil, which are accentuated at the transition from the trailing edge section to the fixation post.

### LINEOUT OF THE SUBJECT MATTER OF THE PRESENT DISCLOSURE

It is an object of the present disclosure to provide an improved turboengine blading member. According to one aspect of the present disclosure structural integrity and lifetime of the blading member shall be improved. In more specific aspects, stress concentrations at a tip and/or a base of an airfoil in a transitional area to the platform shall be reduced. In certain aspects of the present disclosure a turboengine blading member shall be disclosed which is particularly well-suited to be assembled from separately prepared blading and platform members.

This is achieved by the subject matter described in claim 1 and further in the independent claims claiming an airfoil member for a turboengine blading member.

Further effects and advantages of the disclosed subject matter, whether explicitly mentioned or not, will become apparent in view of the disclosure provided below.

Accordingly, a turboengine blading member is disclosed which comprises at least one airfoil and at least one platform provided at at least one of a base and a tip of the airfoil. The airfoil comprises, a profile body, a leading edge provided at a first side of the profile body, and a trailing edge section extending from a second side of the profile body and opposite the leading edge. It will be readily understood that the leading edge defines an upstream side of the airfoil, and the trailing edge defines a downstream side of the airfoil. The profile body is connected to the at least one platform. The profile body may extend from the platform in one piece or may otherwise be suitably joined to the platform. The trailing edge section cantilevers from the profile body and is provided without connection to the platform. Thus, there is no rigid connection between the trailing edge section and the platform. The trailing edge may thus displace relative to the platform and may therefore compensate, for instance, different thermal expansion. The trailing edge section, which, by nature, due to its required low thickness, constitutes a mechanically weak part of the blading member is isolated from forces induced by the support of the airfoil on the platform. The trailing edge section cantilevers from the profile body in a smooth and continuous manner, without any sudden changes in cross section, thus avoiding notch effects. The skilled person will readily appreciate how this serves to considerably reduce vulnerability to fatigue.

In another aspect, the trailing edge section may even cantilever beyond a downstream edge of the platform, such that at least a part of the trailing edge section is located downstream of the platform. This in turn provides the capability to design the platform with a reduced axial space requirement in the turboengine.

A gap may be provided at an interface between the trailing edge section and the platform member.

In more specific aspects of the herein disclosed subject matter, a recessed indentation may be provided on a working fluid exposed side of the platform, and an end of the trailing edge section is received in said indentation such that an interface between the platform and the trailing edge section is located in the indentation. It will be readily understood in this respect that an end of the cantilevering trailing edge section is to be understood as an end when seen along the extent of the trailing edge, and said end is in particular an end and more in particular an end face which faces the platform. By virtue of this arrangement, the trailing edge section provided in said indentation and the platform jointly form a labyrinth seal, which, on the one hand, reduces working fluid ingestion in the interface between the cantilever in trailing edge section and the platform, and on the other hand reduces or even avoids leakage flow from the pressure side of the airfoil to the suction side of the airfoil through the interface between the trailing edge section and the platform.

Said sealing effect gets the more effective the smaller the leakage gaps are. The shape of said recessed indentation, in a plan view onto the working fluid exposed side of the platform thus may, in particular closely, follow or resemble the shape of a cross sectional aspect of the trailing edge section in said view direction. In an aspect, a space is provided between side surfaces of trailing edge section and the side walls of the indentation. The skilled person will readily understand the meaning of a plan view in the present context. The skilled person will also readily appreciate that the cross sectional aspect of the trailing edge section may in this respect particularly refer to a cross section taken across and in particular perpendicular to the extent of the trailing edge.

The recessed depression may be provided with an enclosed outline, but may in other embodiments be open at its downstream end, i.e. adjacent the trailing edge, and extend to a downstream end of the platform, wherein downstream, as will be readily appreciated, refers to the working fluid flow direction for which the blading member is designed and provided.

In certain embodiments, means are provided to supply a coolant to an interface between the platform and the trailing edge section. Said coolant may be provided through appropriate ducts from within the airfoil. According to other embodiments, coolant supply means are provided, arranged and configured to provide coolant from a coolant side of the platform to the interface between the platform and the trailing edge section. A combination of both is possible. In purging the interface formed between the trailing edge section and the platform with a coolant, in particular with cooling air, hot working fluid ingestion is at least reduced if not avoided, and the transition area between the trailing edge section and the profile body, where accordingly a notch effect may be present, is particularly well cooled. Further, the coolant flow may be directed such as to provide an aerodynamic sealing which reduces or even prevents leakage flow of working fluid from the airfoil pressure side to the airfoil suction side through the interface.

According to another aspect of the present disclosure, the airfoil is provided on an airfoil member, the platform is provided on a platform member, and the airfoil member and the platform member are interlocked with each other. This allows the platform member and the airfoil member to be manufactured from different materials, and/or according to different processes. For instance, the blading member may be obtained from a directional solidification process, while a more cost effective process and/or a material may be used for the platform member. Moreover, it is noted that in assembling the blading member from individual members, smaller individual members with more uniform cross sections are required, which facilitates processing, such as for instance casting and coating. Further, a higher flexibility in machining the individual members is achieved, as tooling access to the airfoil member is not impeded by the platform, and vice versa.

In certain embodiments, the platform member comprises a receiver opening and the airfoil member comprises at least one fixation post provided at at least one of the airfoil base and the airfoil tip, wherein the fixation post is received within the receiver opening in a mating relationship. The platform member comprises at least one first retainer groove provided inside the receiver opening and the airfoil member comprises at least one second retainer groove provided on the fixation post. A first and a second retainer groove jointly form a retainer cavity, and a retainer member is provided inside the retainer cavity, thus providing an interlock between the airfoil member and the platform member. It is understood, that in applying said embodiments, the airfoil member and the platform member may be disassembled in removing the retainer member from the retainer cavity. This allows easy reconditioning of a worn blading member, as each of the members may be reconditioned and/or replaced individually.

It is noted that in certain embodiments the blading member may widen in cross section at a transition to the fixation post, such that part of the platform may be said to be provided by the fixation post.

The retainer member may in particular be prepared in situ, in particular in molding a liquid casting slip into the interlock cavity and solidifying the liquid casting slip within the interlock cavity, for instance in applying methods as described in U.S. Pat. No. 5,797,725 or U.S. Pat. No. 8,257,038, which are commonly referred to as bi-cast and injection molding, respectively. The respective content of the named US patents is included herein by reference.

In that respect, according to an aspect of the present disclosure, the turboengine blading member comprises an airfoil member wherein the fixation post extends from the airfoil member profile body and the leading edge section cantilevers from a common structure jointly formed by the profile body and the fixation post. It is understood in this respect, that a fixation post is provided at and extends from at least one of an airfoil base and an airfoil tip, and extends along a spanwidth direction of the airfoil. In more specific embodiments the fixation post at least essentially covers a cross sectional aspect of the profile body, leaving a cross sectional aspect of the trailing edge section free.

Accordingly, an airfoil member for a turboengine blading member is disclosed, wherein the airfoil member comprises an airfoil, the airfoil comprising a profile body, a leading edge provided at a first side of the profile body and a trailing edge section extending from a second side of the profile body and opposite the leading edge. At least one fixation post is provided at at least one of an airfoil tip and an airfoil base. The fixation post at least essentially covers a cross sectional aspect of the profile body, leaving a cross sectional aspect of the trailing edge section free. In particular, the fixation post is provided and arranged and configured to be received within and mate with a receiver opening of a platform member.

The turboengine blading member may further be provided with a clearance provided between a side of the fixation post pointing in a downstream direction of the airfoil member and a wall section of the receiver opening arranged at a downstream side of the receiver opening, each with respect to the flow direction for which the airfoil is intended and is defined by the arrangement of the leading edge and the trailing edge. The fixation post, the platform member receiver opening and the retainer member jointly form an at least essentially hermetically sealed joint spanning a circumferential extent of the profile body, in particular extending along the suction side, the leading edge, and the pressure side. Said clearance forms a duct for a coolant to be provided from a coolant side of the platform to an interface between the trailing edge section and the platform. This may be achieved in that the retainer member is provided as an open clip extending along a section of the joint spanning the fixation post circumference on a suction side of the airfoil member, a section of the joint spanning the fixation post circumference around the leading edge of the airfoil member, and a section of the joint spanning the fixation post circumference on the pressure side of the airfoil member, while being open towards a downstream side of the airfoil member.

It will be readily appreciated that, at least for airfoils being intended for use in subsonic flows, as is commonly the case in the expansion turbine of an internal combustion turboengine, a suction side of the airfoil member is the side of the airfoil member on which the airfoil profile body exhibits a convex contour from the leading edge to the trailing edge section. Likewise, the pressure side of the airfoil member is the side of the airfoil member on which the airfoil profile body exhibits a concave contour from the leading edge to the trailing edge section. The skilled person will readily perceive the leading edge and the trailing edge of the airfoil, and in turn the leading edge side and the trailing edge side, or upstream and downstream side, respectively, of the airfoil member.

In yet other aspects of the herein described turboengine blading member, the receiver opening, the fixation post and the retainer member form a hermetically sealed joint, and at least one coolant supply duct is provided to allow a coolant to be supplied from a coolant side of the platform and/or from within the airfoil to an interface between the platform and the trailing edge section. In said instance, the retainer member may in particular be provided as a closed circumferential member spanning the entire circumference of the fixation post. It will become readily apparent, that the circumference or circumferential in this respect does not refer to a necessarily circular figure, but relates to a line running around and following the contour of the fixation post.

Reverting to the airfoil member to which reference was made above, at least one retainer groove may be provided on the fixation post. Said retainer groove may furthermore extend, with a longitudinal extent thereof, at least essentially entirely along a circumferential extent of the fixation post. Said retainer groove may particularly be intended to jointly form a retainer cavity with a groove provided on an inner surface of a receiver opening which is provided within a platform member receiver opening, and be provided, and arranged and configured, accordingly. The retainer cavity in turn is arranged and configured to receive the retainer member.

A platform member for a turboengine blading member is disclosed which comprises a platform, at least one receiver opening being provided therein and extending from a working fluid exposed side of the platform. Said receiver opening is arranged and configured to receive a fixation post of an airfoil member, as lined out above. A recessed indentation is provided on the working fluid exposed side of the platform. Said recessed indentation is provided adjacent to and in communication with the receiver opening, and arranged and configured to receive an end of a cantilevering trailing edge section provided on an airfoil member. In particular, the recessed indentation may, in a plan view onto the platform working fluid exposed side assume the general shape of a cross sectional aspect of a trailing edge section. As lined out above, the meaning of a plan view and the cited cross-sectional view of perfectly clear to the skilled person.

The further described subject matter may be used in connection with the subject matter described above, or may be used independent from the features described above.

In another aspect of the present disclosure a turboengine component, which could be a turboengine blading member or any other turboengine component, is disclosed, wherein the blading member is assembled from an airfoil member and the platform member. The airfoil member comprises a fixation post provided at and extending from at least one of a base and the tip of an airfoil. The platform member comprises a receiver opening, which receives and mates with the fixation post. At least one first groove is provided at an inner surface of the receiver opening and at least one second groove is provided on the fixation post. The first and second fixation groove jointly form a retainer cavity, in which a retainer member is provided, providing for an interlock between the platform member and the airfoil member. The retainer member may in particular have been prepared in situ, in particular in molding a liquid casting slip into the interlock cavity and solidifying the liquid casting slip within the interlock cavity. A method as referred to above as bi-cast or injection molding may be applied. An oblique shoulder is provided within the receiver cavity, the receiver cavity tapering at the oblique shoulder in a direction from a hot gas exposed side towards a coolant side of the platform. As will be appreciated, the hot gas exposed side is the side on which the airfoil is arranged, while the coolant side is arranged opposed the hot gas exposed side of the platform. Further, the oblique shoulder offset from the first groove towards the hot gas side. A counterpart oblique shoulder is disposed on the fixation post and mates with the oblique shoulder provided within the receiver opening. The mating oblique shoulders are offset from the retainer cavity towards the hot gas side of the platform, or the airfoil, respectively. By means of the two mating shoulders, the relative positions of the airfoil member and the platform member are well-defined. The two mating shoulders jointly provide a sealing which on the one hand prevents liquid casting slip from leaking out of the joint interface formed between the fixation post and the inner surface of the receiver opening, and on the other end prevents hot gas from penetrating through the interface between the fixation post and the receiver opening towards the retainer member.

If, however the fixation post and the receiver opening are dimensionally matched such that, when mating them, the play between the fixation post and the receiver opening is minimized, such that for example a resulting clearance does not exceed 0.35 mm, and is particular in a range between and including 0.05 mm and 0.35 mm, no sealing is required as, due to the surface tension of the liquid casting slip, the liquid casting slip is prevented from entering the clearance. Further, the transition areas in which the first and second grooves which form the retainer cavity may be shaped such that the individual grooves merge into the clearance with radii in a range from and including 0.3 mm up to and including 0.5 mm. It will be appreciated that during service the retainer member provided inside the retainer cavity may bear upon said transition edges in performing the retention function. In providing smooth, rounded transitions instead of sharp edges, stresses in the retainer member and fatigue are considerably reduced and lifetime is effectively enhanced.

A gap may be formed between the blading member and the platform member which is open towards the hot gas side. In one embodiment, a coolant supply for purging said gap against hot gas injection is provided. The depth of the gap may be up to 10 mm. Providing the gap with a depth between 5 mm and 10 mm ensures that the retainer member has sufficient distance to the hot gas exposed side of the platform. This is required as the melting point of the solidified casting slip must not be exceeded during operation.

It is noted for the sake of completeness that any blading member described above may comprise one or more airfoils. A platform may be provided at a base of an airfoil, at a tip of an airfoil, or both.

It is understood that the features and embodiments disclosed above may be combined with each other. It will further be appreciated that further embodiments are conceivable within the scope of the present disclosure and the claimed subject matter which are obvious and apparent to the skilled person.

### BRIEF DESCRIPTION OF THE DRAWINGS

The subject matter of the present disclosure is now to be explained in more detail by means of selected exemplary embodiments shown in the accompanying drawings. The figures show

FIG. 1 a schematic view of a first exemplary embodiment of a blading member according to the present disclosure;

FIG. 2 a section of the embodiment of FIG. 1 a long line A-A;

FIG. 3 a view of an airfoil member of an assembled blading member;

FIG. 4 a simplified view of the assembly of an airfoil member and a platform member, with the platform member cut to be able to visualize the internal arrangement of the airfoil member fixation post and the retainer member inside a receiver cavity of an airfoil member, according to a further embodiment according to the present disclosure;

FIG. 5 a section taken along line B-B in FIG. 4;

FIG. 6 a simplified view of the assembly of an airfoil member and a platform member, with the platform member cut to be able to visualize the internal arrangement of the airfoil member fixation post and the retainer member inside a receiver cavity of an airfoil member, according to still a further embodiment according to the present disclosure;

FIG. 7 a section taken along line C-C in FIG. 6;

FIG. 8 a sectional view of a retainer cavity provided to receive a retainer member for interlocking the airfoil member and the retainer member:

FIG. 9 a sectional view of a specific embodiments of a mating fixation post of an airfoil member and receiver opening of a platform member;

FIG. 10 a partial sectional side view of a further exemplary embodiment of a blading member;

FIG. 11 a plan sectional view of the blading member of FIG. 10.

It is understood that the drawings are highly schematic, and details not required for instruction purposes may have been omitted for the ease of understanding and depiction. It is further understood that the drawings show only selected, illustrative embodiments, and embodiments not shown may still be well within the scope of the herein disclosed and/or claimed subject matter.

### EXEMPLARY MODES OF CARRYING OUT THE TEACHING OF THE PRESENT DISCLOSURE

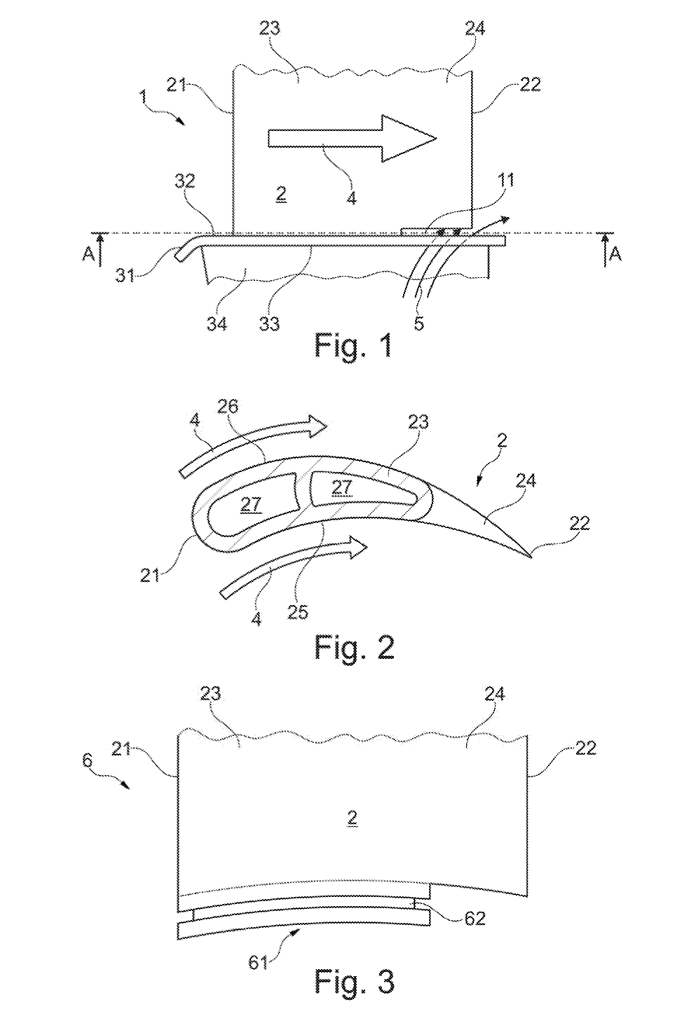

FIG. 1 shows a general side view of a turboengine blading member 1 as described herein. Blading member 1 comprises airfoil 2 and platform 31 disposed at a base of airfoil 2. Airfoil 2 comprises leading edge 21 and trailing edge 22. Accordingly, a hot working fluid flow 4 is intended to flow along airfoil 2 from the leading edge 21 to trailing edge 22, and along a working fluid exposed surface 32 of the platform. Generally, attachment features 34 are provided at a coolant side 33 of the platform in order to attach the blading member 1 to a rotor or a stator. The attachment features are shown only as a schematic depiction, and are features well-known to the skilled person. Generally, during operation of the engine, a coolant is provided at the platform 31 on the coolant side 33. Said coolant may in a manner known per se be used to cool the platform, but may, as well known to the skilled person, also be guided into the interior of the airfoil, and may be discharged from there through openings provided in the airfoil. The airfoil is connected to the platform at the profile body 23, while at a trailing edge section 24 cantilevers from the profile body 23 and is provided without connection to the platform 31. A gap 11 is formed between the trailing edge section 24 of the airfoil and the platform. Appropriate means, such as coolant channels, may be provided in the platform to allow a flow 5 of coolant from beneath the platform to purge the gap 11 and prevent hot gas ingestion into the gap.

FIG. 2 depicts a cut along line A-A in FIG. 1. The airfoil 2 comprises a pressure side 25 and a suction side 26, each extending from the leading edge 21 to the trailing edge 22. A profile body 23 provides for a profile thickness. Trailing edge section 24 cantilevers from the profile body 23. For reference only, simplified examples of coolant ducts 27 are shown through which a coolant from beneath the platform may enter the airfoil, and may in a manner known per se be used to cool the airfoil and may for instance be discharged through appropriate openings provided at the leading edge, at the trailing edge, at the suction side, and/or at the pressure side. The working fluid flow is intended to flow around airfoil 2 as denoted at 4.

It is known in the art to provide blading members which are assembled from at least one airfoil member and at least one platform member. Certain benefits of providing individual airfoil and platform members have been lined out above. It is for instance known from U.S. Pat. No. 5,797,725 to provide a platform member with a receiver opening in which a fixation post of the blading member is received. Respective grooves formed on the fixation post and on an inner surface of the receiver opening jointly form a retainer cavity, into which a liquid casting slip is molded and is subsequently solidified, thus preparing a retainer member inside the retainer cavity in situ. FIG. 3 depicts a partial of view an airfoil member which may be used in connection with a herein disclosed blading member. Airfoil member 6 comprises airfoil 2 and fixation post 61. Fixation post 61 comprises a groove 62 provided on its outer surface. Fixation post 61 is intended to be received in and mate with a receiver opening formed in a platform member. Groove 62 is intended to be placed in conformity with a corresponding groove provided on an inner surface of the receiver opening of the platform member, and to jointly form a retainer cavity with said groove formed in the platform member. Subsequently, a liquid casting slip may be molded into the jointly formed retainer cavity and be solidified inside the retainer cavity, thus providing an interlock between the airfoil member and the platform member. In particular, such connection will provide an at least essentially gas tight sealing of the joint between the airfoil member and the platform member.

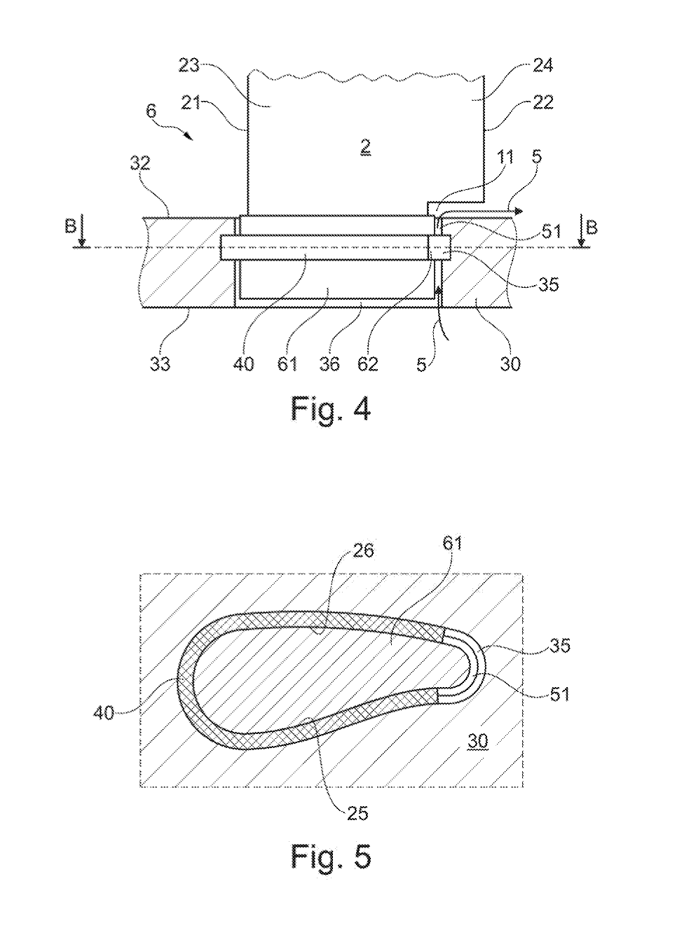

FIG. 4 depicts a simplified view of the assembly of an airfoil member and a platform member, with the platform member cut to visualize the internal arrangement of the airfoil member fixation post 61 and a retainer member 40 inside a receiver cavity 36 of a platform member 30, according to a further embodiment according to the present disclosure. FIG. 5 shows a much simplified and schematic view of section B-B of FIG. 4. Platform member 30 comprises a working fluid exposed surface 32 and a coolant side surface 33. It furthermore comprises a receiver opening 36, in which a fixation post 61 of airfoil member 6 is received. Airfoil member 6 further comprises, as lined out above in connection with FIG. 3, an airfoil 2, which in turn comprises leading edge 21 and trailing edge 22. In the manner lined out above, airfoil 2 comprises airfoil profile body 23 and a trailing edge section 24 cantilevering therefrom. Leading edge 21 is provided on airfoil profile body 23. Trailing edge 22 is provided on trailing edge section 24. It goes without saying that airfoil profile body 23, airfoil trailing edge section 24 and fixation post 61 are provided as a one-piece airfoil member 6. Groove 62 provided on the fixation post and a groove 35 provided on the interior surface of receiver opening 36 jointly form a retainer cavity, in which a retainer member 40 is provided. As is seen, a clearance 51, the width thereof typically being in a range of some tenths of a millimeter, is formed between the inner wall of receiver opening 36 and an outer surface of fixation post 61. As is seen in connection with FIG. 5, retainer member 40 extends around the circumference of fixation post 61 on a pressure side 25 of the airfoil member, around the leading edge, and along the suction side 26 of the airfoil member, providing an at least essentially gas-tight sealing of the joint between the fixation post and the receiver opening, while being open on a trailing edge or downstream side. It should be noted in connection with FIG. 5, although obvious to the skilled person, that while, for the sake of easier schematic depiction, fixation post 61 is shown as a solid body, usually coolant ducts are provided therein, which comes to the skilled person without saying. In that retainer member 40 is open on a trailing edge or downstream side, clearance 51 serves as a coolant supply clearance provided between an inner wall of the receiver opening 36 and fixation post 61, providing a fluid connection between coolant side 33 of the platform and gap 11, gap 11 being formed between the cantilevering trailing edge section 24 of airfoil 2 and the hot gas exposed side 32 of the platform. A coolant flow 5 is thus provided through supply clearance 51 to gap 11, and avoids ingestion of hot working fluid into gap 11.

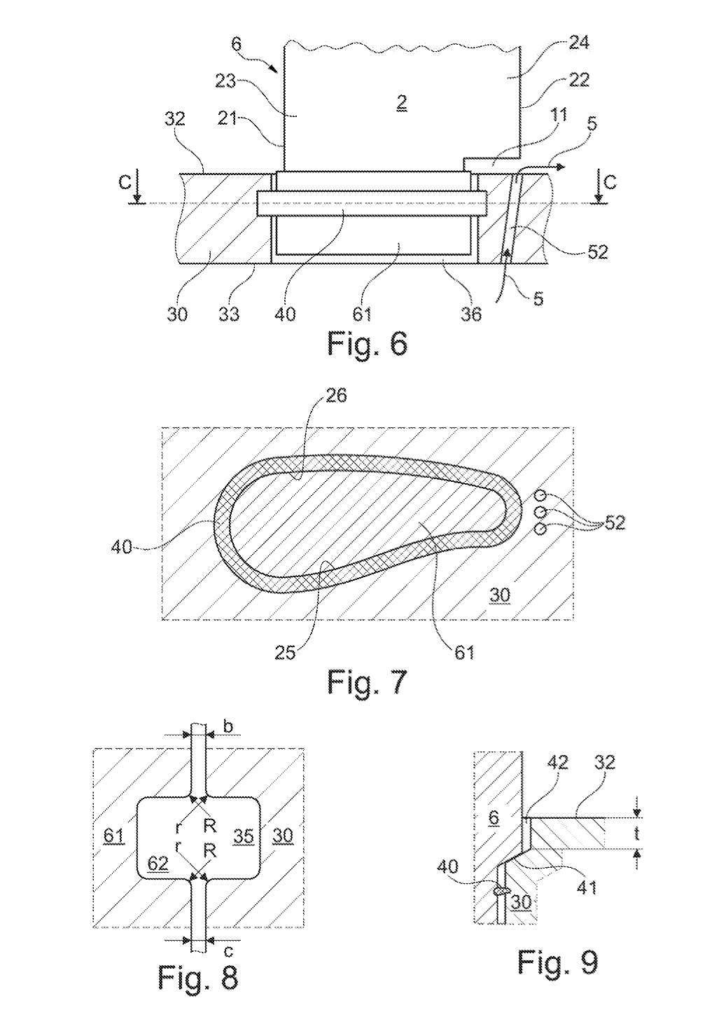

FIG. 6 depicts a simplified view of the assembly of a further exemplary embodiment of an airfoil member 6 and a platform member 30, with the platform member cut to visualize the internal arrangement of airfoil member fixation post 61 and retainer member 40 inside a receiver cavity 36 of platform member 30. FIG. 7 shows a much simplified and schematic view of section C-C of FIG. 6. Platform member 30 comprises a working fluid exposed surface 32 and a coolant side surface 33. It furthermore comprises a receiver opening 36, in which a fixation post 61 of airfoil member 6 is arranged. Airfoil member 6 further comprises, as lined out above in connection with FIG. 3, airfoil 2, which in turn comprises leading edge 21 and trailing edge 22. In the manner lined out above, airfoil 2 comprises airfoil profile body 23 and trailing edge section 24 cantilevering therefrom. Leading edge 21 is provided on airfoil profile body 23. Trailing edge 22 is provided on trailing edge section 24. A groove provided on the fixation post in the manner shown in FIG. 3 and a groove provided on the interior surface of receiver opening 36 jointly form a retainer cavity, in which retainer member 40 is provided. Both grooves are not visible in the present depiction as retainer member 40 fills the entire retainer cavity, but are obvious to the skilled person by virtue of FIGS. 3 and 4. As is seen, a clearance, the width thereof typically being in a range of some tenths of a millimeter, is formed between the inner wall of the receiver opening 36 and an outer surface of fixation post 61. As is seen in connection with FIG. 7, retainer member 40 extends around the entire circumference of fixation post 61 on a pressure side 25 of the airfoil member, around the leading edge side, and along the suction side 26 of the airfoil member, and being closed towards the trailing edge or on a downstream side, providing an at least essentially gas-tight sealing of the joint between the fixation post and the receiver opening. It should be noted in connection with FIG. 7, although obvious to the skilled person, that while, for the sake of easier schematic depiction, fixation post 61 is shown as a solid body, usually coolant ducts are provided therein, which comes to the skilled person without saying. As retainer member 40 is closed on a trailing edge or downstream side, and thus complete sealing of the joint of the fixation post and the receiver cavity is provided, platform member 30 comprises coolant supply means 52 provided to enable a coolant flow 5 to gap 11 formed between the cantilevering trailing edge section 24 of airfoil 2 and platform hot gas exposed side 32, thus purging gap 11 and reducing or even avoiding ingestion of hot working fluid into gap 11.

The cantilevering distance of the trailing edge section is determined by space requirements and lifetime considerations. As seen in FIGS. 4 through 7, a gap formed between the cantilevering trailing edge section may be purged with coolant to reduce or even prevent hot working fluid ingestion and in turn overheating. The means to provide the purging fluid flow may be provided in that the retainer member is provided as an open clip which is open towards the trailing edge, or on a downstream side, respectively, and/or in providing coolant supply means, for instance cooling holes, which allow a flow of coolant from the coolant side of the platform to the gap formed between the cantilevering trailing edge section and the hot working fluid flow exposed surface of the platform.

In another aspect of the present disclosure, FIG. 8 depicts a sectional view through a retainer cavity, which is comprised of a groove 35 provided in platform member 30, and a groove 62 provided on fixation post 61 of an airfoil member. A clearance is provided between the airfoil member fixation post and the platform member. Clearance widths b and c between an inner wall of the receiver opening of platform member 30 and fixation post 61 adjacent the retainer cavity are chosen to be in a range between 0.08 mm and 0.32 mm. In providing the clearance widths inside said specific range, sealing of the clearance is not required during preparation of the retainer member inside retainer cavity in molding a liquid casting slip. In particular, the surface tension of the liquid casting slip may avoid liquid casting slip from leaking through the clearance. In addition, radii r and R at a transition between the member surfaces and the grooves may be chosen in a range equal to or larger than 0.3 mm, and smaller than or equal to 0.5 mm.

In yet another aspect of the present disclosure, FIG. 9 depicts an embodiment wherein airfoil member 6 and platform member 30 mutually bear upon a tapered bearing section 41 provided by two correspondingly sloped surfaces provided on airfoil member 6 and platform member 30, and are interlocked by retainer member 40. A gap 42 is be formed between the blading member and the platform member which is open towards the working fluid exposed side 32 of the platform. The melting point of the solidified casting slip of which retainer member 40 consists must not be exceeded during operation. In one embodiment, a coolant supply for purging said gap against hot gas ingestion may be provided. The depth t of the gap may be up to 10 mm. Providing the gap with a depth t between 5 mm and 10 mm ensures that the retainer member has sufficient distance to the hot working fluid exposed side 32 of the platform. This enables to reduce or even omit coolant purging of gap 42 while excess heating of retainer member 40 during operation is avoided.

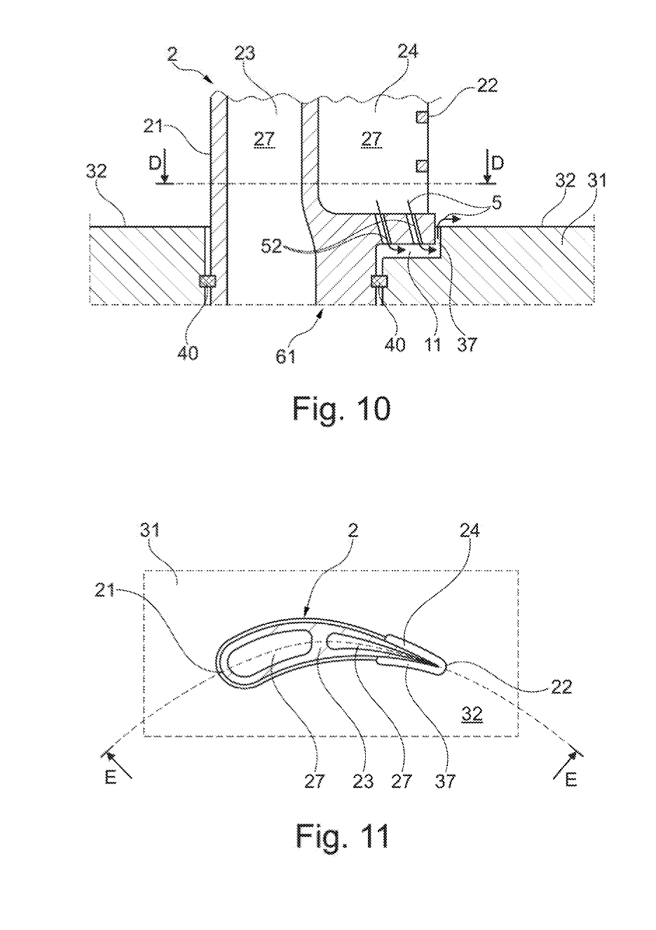

With reference to FIGS. 10 and 11, a further exemplary embodiment of the herein described turboengine blading member is illustrated. FIG. 11 shows a sectional view along line D-D of FIG. 10, while FIG. 10 shows a sectional view along line E-E of the FIG. 11. With reference to FIG. 10, coolant ducts 27 are provided in airfoil 2. An upstream coolant duct, located adjacent leading edge 21, extends through fixation post 61 and into airfoil 2. Coolant from beneath the platform may be guided through said coolant duct into the airfoil. In a manner not shown, but perfectly known to the person skilled in the art, coolant may be discharged through the cooling holes provided in the airfoil. In a manner further known to the skilled person, coolant which is not discharged may be reverted flow direction at an airfoil tip and be guided to a downstream cooling channel, located at the trailing edge, and be discharged through coolant slits provided at the trailing edge. Other cooling schemes and further cooling features provided inside the airfoil 2 are familiar to the skilled person. A recessed indentation 37 is provided on the platform. An end of the cantilevering trailing edge 24 is located inside recess 37, and forms a gap 11 with the platform inside the recessed indentation. As becomes apparent in view of FIG. 11, which depicts a plan view onto the working fluid exposed side 32 of platform 31, recess 37 closely follows or resembles the general shape of a cross sectional aspect of the trailing edge section. With reference to FIG. 10, coolant supply holes 52 are provided at an end of the trailing edge section 24, and serve as coolant supply means to supply a coolant and purging flow 5 to the interface gap 11 between the trailing edge section and the platform.

While in this exemplary embodiment the recessed indentation is shown to be provided on a platform member, a foot section of the airfoil member may be shaped to include said recessed indentation with an end of the cantilevering trailing edge located therein. In other instances, the airfoil and the platform may be provided as a monobloc member, with an end of the cantilevering trailing edge being provided in a recessed indentation. Further, while in this exemplary embodiment the recessed depression is provided with an enclosed outline, it may in other embodiments be open at its downstream end, i.e. adjacent the trailing edge, and extend to a downstream end of the platform. Downstream, as will be readily appreciated, refers to the working fluid flow direction for which the blading member is designed and provided.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

### LIST OF REFERENCE NUMERALS

1 blading member

2 airfoil

4 working fluid flow

5 coolant flow

6 airfoil member

11 gap between trailing edge section and platform

21 leading edge

22 trailing edge

23 profile body of airfoil

24 trailing edge section of airfoil

25 pressure side of airfoil

26 suction side of airfoil

27 coolant duct

30 platform member

31 platform

32 working fluid exposed surface of platform

33 coolant side of platform

34 platform attachment feature

35 retainer groove provided on interior surface of platform member receiver cavity

36 receiver opening provided in platform member

37 recessed indentation

40 retainer member

41 tapered bearing section

42 gap

51 coolant supply means, coolant supply clearance, coolant supply duct

52 coolant supply means, coolant supply holes, coolant supply duct

61 fixation post

62 retainer groove provided on fixation post

b clearance width

c clearance width

r radius

t depth of gap

R radius

1. A turboengine blading member, the blading member comprising at least one airfoil and at least one platform provided at at least one of a base and a tip of the airfoil, the airfoil comprising a profile body, a leading edge provided at a first side of the profile body, and a trailing edge section extending from a second side of the profile body and opposite the leading edge, wherein the profile body is connected to the at least one platform, wherein the trailing edge section cantilevers from the profile body and is provided without connection to the platform.

2. The turboengine blading member according to the claim 1, wherein a recessed indentation is provided on a working fluid exposed side of the platform and an end of the trailing edge section is received in said indentation such that an interface between the platform and the trailing edge section is located in the indentation.

3. The turboengine blading member according to claim 2, wherein the shape of the indentation, in a plan view onto the working fluid exposed side of the platform follows the shape of a cross sectional aspect of the trailing edge section in said view direction.

4. The turboengine blading member according to the claim 1, wherein means are provided to supply a coolant to an interface between the platform and the trailing edge section.

5. The turboengine blading member according to claim 4, wherein said coolant supply means are provided, arranged and configured to provide coolant from at least one of a coolant side of the platform and an interior of the airfoil to the interface between the platform and the trailing edge section.

6. The turboengine blading member according to the claim 1, wherein the airfoil is provided on an airfoil member, the platform is provided on a platform member, and the airfoil member and the platform member are interlocked with each other.

7. The turboengine blading member according to claim 6, wherein the platform member comprises a receiver opening and the airfoil member comprises at least one fixation post provided at at least one of the airfoil base and the airfoil tip, wherein the fixation post is received within the receiver opening , the platform member comprising at least one first retainer groove provided inside the receiver opening, the airfoil member comprising at least one second retainer groove provided on the fixation post, a first and a second retainer groove jointly forming a retainer cavity, and wherein a retainer member is provided inside the retainer cavity thus providing an interlock between the airfoil member and the platform member.

8. The turboengine blading member according to claim 7, wherein the fixation post extends from the airfoil profile body and the trailing edge section cantilevers from a common structure jointly formed by the profile body and the fixation post.

9. The turboengine blading member according to claim 8, wherein the fixation post at least essentially covers a cross sectional aspect of the profile body, leaving a cross sectional aspect of the trailing edge section free.

10. The turboengine blading member according to the claim 6, wherein a clearance is provided between a side of the fixation post pointing in a downstream direction of the airfoil member and a wall section of the receiver opening arranged at a downstream side of the receiver opening, said downstream directions referring to the flow direction for which the airfoil is intended, thus providing a supply duct for a coolant to be provided from a coolant side of the platform to an interface between the trailing edge section and the platform, while the fixation post, the platform member receiver opening and the retainer member jointly form an at least essentially hermetically sealed joint spanning a circumferential extent of the profile body which is open towards the trailing edge.

11. The turboengine blading member according to claim 10, wherein the retainer member is provided as an open clip extending along a section of the joint spanning the fixation post circumference on a suction side of the airfoil member, a section of the joint spanning the fixation post circumference around the leading edge of the airfoil member, and a section of the joint spanning the fixation post circumference on the pressure side of the airfoil member, while being open towards the trailing edge of the airfoil member.

12. The turboengine blading member according to the claim 6, wherein the receiver opening, the fixation post and the retainer member form a hermetically sealed joint, and at least one coolant supply duct is provided to allow a coolant to be supplied from at least one of a coolant side of the platform and an interior of the airfoil to an interface between the platform and the trailing edge section.

13. The turboengine blading member according to claim 12, wherein the retainer member is provided as a closed circumferential member spanning the entire circumference of the fixation post.

14. An airfoil member for a turboengine blading member, the airfoil member comprising an airfoil, the airfoil comprising a profile body, a leading edge provided at a first side of the profile body and a trailing edge section extending from a second side of the profile body and opposite the leading edge, at least one fixation post being provided at at least one of an airfoil tip and an airfoil base, wherein the fixation post at least essentially covers a cross sectional aspect of the profile body, leaving a cross sectional aspect of the trailing edge section free.

15. A platform member for a turboengine blading member, comprising a platform, the platform member comprising at least one receiver opening provided therein and extending from a working fluid exposed side of the platform and arranged and configured to receive a fixation post of an airfoil member, a recessed indentation being provided on the working fluid exposed side of the platform, said recessed indentation being provided adjacent to and in communication with the receiver opening and arranged and configured to receive an end of a cantilevering trailing edge section provided on an airfoil member, wherein in particular in a plan view onto the platform working fluid exposed side the recessed indentation assumes the general shape of a cross sectional aspect of a trailing edge section
